(19) United States
(12) Patent Application Publication
(10) Pub. No.: US 2014/0068476 A1
(43) Pub. Date: Mar. 6, 2014

(54) ICON OPERATING DEVICE

(71) Applicant: Toshiba Alpine Automotive Technology Corporation, Iwaki-shi (JP)

(72) Inventor: Masanori KOSAKI, Fukushima-ken (JP)

(21) Appl. No.: 13/928,836

(22) Filed: Jun. 27, 2013

(30) Foreign Application Priority Data
Sep. 6, 2012 (JP) 2012-196286
Feb. 25, 2013 (JP) 2013-034486

(51) Int. Cl. G06F 3/0481; G06F 3/0482

(52) U.S. Cl. CPC G06F 3/04817; G06F 3/0482
USPC 715/765; 715/835; 715/833

(57) ABSTRACT

According to one embodiment, there is provided an icon operating device. The icon operating device includes: a memory that stores data concerning a plurality of icons that associates information indicating what operation can be made for the device to be operated by touching which part of a user's body with operation contents of the device to be operated; an acquiring unit that acquires a range image of the user; a grasping unit that grasps a shape of the user's body based on the range image data; an identifying unit that identifies, based on a position of a user's finger, an operating position indicating which part of the body the user has touched; and a determining unit that determines selection of the icon and the content of operation for the device to be operated based on the shape of the user's body and the operating position.

### CROSS-REFERENCE TO RELATED APPLICATIONS

This application is based upon and claims the benefit of priority from the prior Japanese Patent Application No. 2012-196286 filed on Sep. 6, 2012 and No. 2013-034486 filed on Feb. 25, 2013, the entire contents of which are incorporated herein by reference.

### FIELD

Embodiments described herein relate generally to an icon operating device used in operation of an on-vehicle device.

### BACKGROUND

When operating a device, it is indispensable to input a command or information to the device. However, when the device requires a complicated input operation or provides poor operability, it is difficult for a user to accept the device even if performance thereof is high.

In order to address the above concern, there are made proposals concerning an easy-to-use and anti-misoperation input operation mechanism. One example of the proposed input operation mechanisms is as follows: a user keeps an operating device to be operated within his or her reach and makes a display unit that displays GUI components on which a command or information is input display a hand shape model image generated from contact information to the device, which allowing the user to operate a desired GUI component while viewing the displayed hand shape model image.

Further, with regard to an input operation of an on-vehicle device, there is proposed an input operation mechanism allowing an input of a shape gesture and a direction gesture so as to allow a driver to operate the on-vehicle device without paying close attention thereto.

However, when the device to be operated located near the user and display unit are away from each other, it is difficult to intuitively grasp a position of an operation surface, so that it is necessary for the driver to turn his or her eyes once to the operation surface or confirm a position of his or her hand while viewing the display unit.

Further, when performing the input operation with a gesture, it is necessary to remember a number of gestures corresponding to various operation contents. Further, variations of the gesture are limited.

### BRIEF DESCRIPTION OF THE DRAWINGS

FIG. 1 is a block diagram illustrating a schematic configuration of an icon operating device according to each of the embodiments of the present invention;

FIG. 2 is a flowchart illustrating a basic processing flow of the icon operating device;

FIG. 3 is a flowchart illustrating a flow of grasping processing of a body shape;

FIG. 4 is a flowchart illustrating a flow of processing of identifying an operating position;

FIG. 5 is a flowchart illustrating a flow of processing of determining presence/absence of the operation;

FIG. 6 is a view illustrating a display example of a user's body and icons;

FIG. 7 is a view illustrating an example of arrangement of an acquiring unit;

FIG. 8 is a view illustrating an example of identification of a face position;

FIG. 9 is a view for explaining depth information of a body;

FIG. 10 is an enlarged view of an area surrounded by a broken line of FIG. 9;

FIG. 11 is a view for explaining an icon touch range with respect to a joint position;

FIG. 12 is a view for explaining a contact position relative to the joint positions;

FIG. 13 is a display example in which the icons are placed on a palm;

FIG. 14 is a view illustrating an example of display of deformed icons;

FIG. 15 is a view illustrating an example of icons displayed on a display unit 11;

FIG. 16 is a display example of a horizontally-reversed user's body and icons;

FIG. 17 is another display example of the icons on the face or body;

FIG. 18 is a display example of the icons using each section of the hand;

FIG. 19 is a detailed display example of the user's hands and icons;

FIG. 20 is a view exemplifying an icon operable range; and

FIG. 21 is an example of designated areas where indications of the portions to be touched are shifted in a case where the icons are placed on detailed portions of the fingers or where the entire palm is iconized.

### DETAILED DESCRIPTION

According to one embodiment, there is provided an icon operating device for a user to input a command or information to a device to be operated. The icon operating device includes: a memory that stores data concerning a plurality of icons that associates information indicating what operation can be made for the device to be operated by touching which part of a user's body with operation contents of the device to be operated; an acquiring unit that is disposed so as to face the user and acquires a range image of the user; a grasping unit that grasps a shape of the user's body based on the range image data acquired by the acquiring unit; an identifying unit that identifies, based on a position of a user's finger obtained by the grasping unit, an operating position indicating which part of the body the user has touched; a determining unit that determines selection of the icon and the content of operation for the device to be operated based on the shape of the user's body and the operating position; and an operation instructing unit that issues an operation instruction to the device to be operated based on the determined operation content.

Embodiments of the present invention will be described below with reference to the drawings. Throughout the drawings, the same reference numerals are used to designate the same components, and redundant descriptions thereof are omitted.

### First Embodiment

In an icon operating device according to a first embodiment, a user makes a simple illustration of his or her body displayed on a screen of a display unit and puts an icon on the illustration. Touching a part of the body corresponding to the icon allows the icon to be selected.

The icon operating device according to the present embodiment may be embodied by a general-purpose computer such as a personal computer including an arithmetic processing unit (CPU), a main memory (RAM), a read only memory (ROM), an input unit (e.g., an operation panel), and a storage unit such as a hard disk drive or a solid state drive (SSD) using a flash memory which is a semiconductor memory. Functions of the icon operating device can be realized by installing a processing program for supporting icon operation in the device.

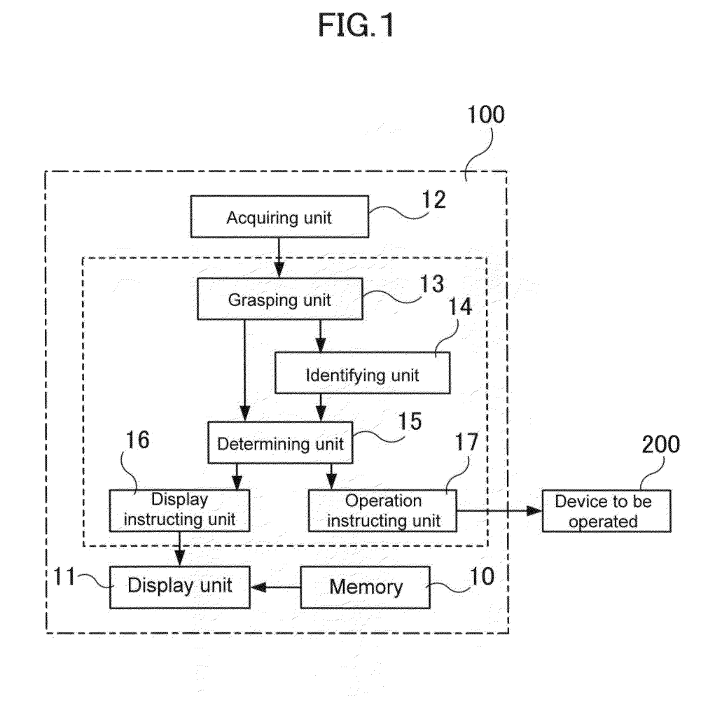

FIG. 1 is a block diagram illustrating a schematic configuration of the icon operating device according to each of the embodiments of the present invention. An icon operating device 100 according to the first embodiment mainly includes a memory 10, a display unit 11, an acquiring unit 12, a grasping unit 13, a identifying unit 14, a determining unit 15, a display instructing unit 16, and an operation instructing unit 17.

The icon operating device 100 issues an instruction from the operation instructing unit 17 to a device 200 to be operated, thereby operating the device 200. The device 200 to be operated is, e.g., an on-vehicle stereo system. When receiving a volume-up instruction from the operation instructing unit 17, the device 200 turns up the volume.

The grasping unit 13, identifying unit 14, determining unit 15, display instructing unit 16, and operation instructing unit 17 are each realized by software cooperating with hardware constituting a computer and operate under a well-known operating system.

The memory 10 stores data concerning a plurality of icons associated with operation contents of the device 200. The icons may display different operation contents from each other. Further, the operation content may be displayed in a hierarchical structure with one icon.

The display unit 11 displays what operation can be made for the device to be operated by touching which part of the body. Specifically, the display unit 11 displays a picture or an illustration of a part of a user's body. For example, as the display unit 11, a head-up display (HUD) that projects information directly into a human's visual field is preferably used. Further, as the display unit 11, a liquid crystal display, a projector, a glasses-free stereoscopic display, a polarized-glasses display, a hologram, or a head-mount display can be used.

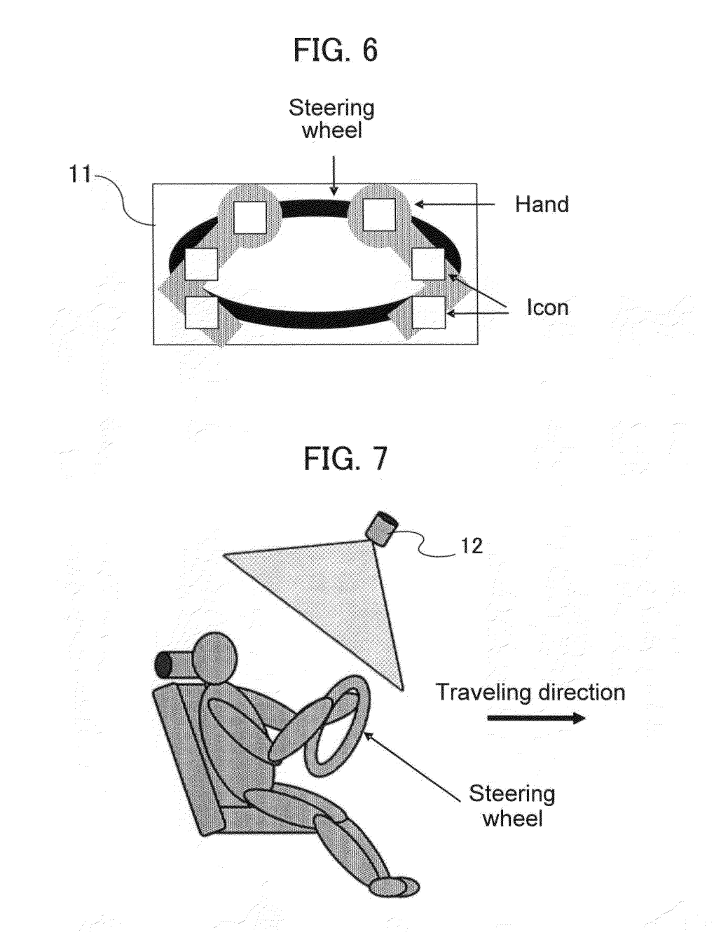

FIG. 6 is a view illustrating an example of icon display. In the example of FIG. 6, the display unit 11 displays a picture of hands gripping a steering wheel and the icons on the picture. In the example of FIG. 6, left and right hands are displayed, and total six icons are placed thereon: two are placed on left and right hand backs (from wrist to bases of fingers) each representing an outside surface of each hand in a state where the hand grips the steering wheel; two are placed on left and right front arm portions (from elbow to wrist); and two are placed on left and right brachial regions (upper arms) (from shoulder to elbow). The icons may display different operation contents from each other. Further, the operation content may be displayed in a hierarchical structure with one icon.

The user views the display illustrated in FIG. 6 and can immediately determine what operation can be made by touching which part of his or her hands or arms. Repetitive use makes it easy for the user to learn the operation (input operation) using the icon display through the user's body and, eventually, he or she finds that he or she can perform the operation without viewing the display on the display unit.

The acquiring unit 12 acquires a range image. The acquiring unit 12 is preferably a stereo camera or a depth sensor. The stereo camera photographs an object from a plurality of directions simultaneously to thereby allow depth-direction information thereof to be recorded. In order to acquire a distance from a stereo image, a principle of triangulation is used in general. The depth sensor irradiates a certain range with infrared ray to produce a state where fine dots are distributed. A pattern of the fine dots is changed depending on an object that exists in the range, and the depth sensor captures the change in the dot pattern to thereby obtain the depth information. FIG. 7 is a view illustrating an example of arrangement of the acquiring unit 12. In the example of FIG. 7, the acquiring unit 12 is arranged on an upper front side with respect to a driver.

The grasping unit 13 determines a shape of the body of a user operating the device to be operated. The grasping unit 13 determines the body shape based on the range image obtained by the acquiring unit 12. Basically, the body shape can be grasped by a head position, a face position, a shoulder position, a hand position, and the like. Details of the body shape determination will be described later.

The identifying unit 14 identifies an operating position based on positions of fingers obtained by the grasping unit 13. Details of the operating position determination will be described later.

The determination unit 15 determines which icon has been selected based on a positional relationship between the user's body and operating hand. Details of the operation determination will be described later.

The display instructing unit 16 switches display content of the display unit 11 depending on the selected icon. For example, when the icon is touched, the display instructing unit 16 changes a size or a color of the touched icon so as to represent a pressed state of the icon. Further, when there are options of the next hierarchy for a selected icon, the display of the selected icon is switched.

The operation instructing unit 17 issues an operation instruction corresponding to the selected icon to the device 200 to be operated. For example, when an icon indicating “volume-up” is selected, the operation instructing unit 17 issues a volume-up instruction to the device 200.

The following describes a basic processing flow of the icon operating device 100 having the above configuration.

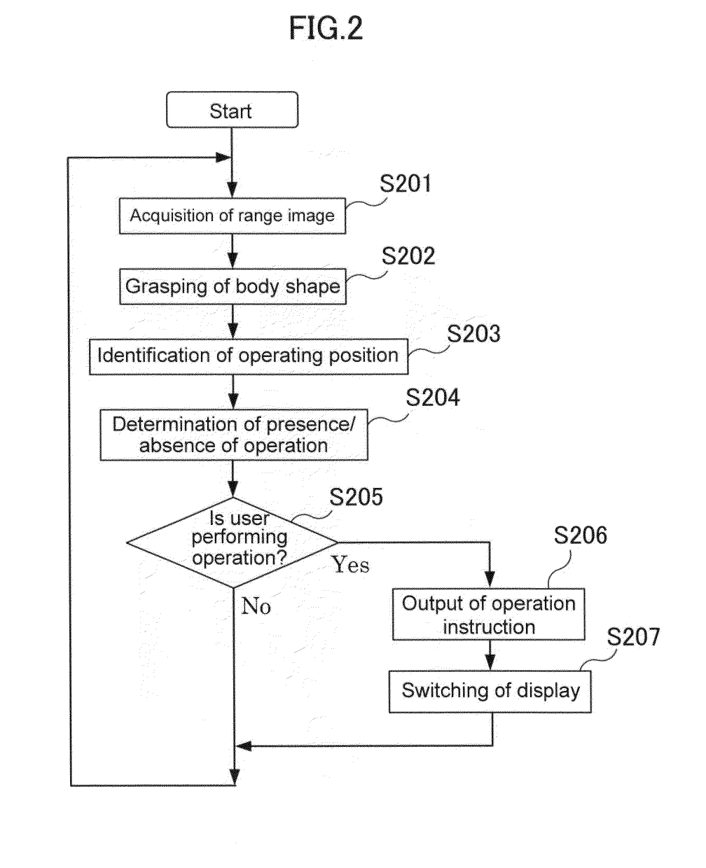

FIG. 2 is a flowchart illustrating a basic processing flow of the icon operating device 100. The icon operating device 100 according to the present embodiment displays a simple picture of the user's body on which the icon is placed. The user touches a part of the body on which the icon is placed to thereby allow selection of the icon.

First, the range image is acquired by using a depth sensor or stereo camera serving as the acquiring unit 12 (step S201).

The shape of the user's body is grasped (step S202). This is performed in order to identify a position of the body relative to a position of the icon displayed on the display unit 11. Details of the grasping in this step will be described later.

Based on the positions of the fingers obtained by the grasping unit 13, an operating position indicating which part of the body the user has touched is identified (step S203). Details of the identification in this step will be described later.

Based on the shape of the user's body and operating position, presence/absence of the selection of the icons arranged on a screen of the display unit 11 and user's operation for the device 200 is determined (step S204). Similarly, details of the determination in this step will be described later.

It is determined whether or not the user is performing operation (step S205). When it is determined that the user is performing operation (Yes in step S205), an operation instruction is output to the device 200 (step S206), and display content of the display unit 11 is switched depending on the selected icon (step S207).

On the other hand, it is determined that the user is not performing operation (No in step S205), the flow returns to step S201.

In the basic processing flow illustrated in FIG. 2, it is not inevitable that this routine should be ended, excluding a case where the icon operating device 100 is powered off or where a vehicle is stopped.

### <Grasping of Body Shape>

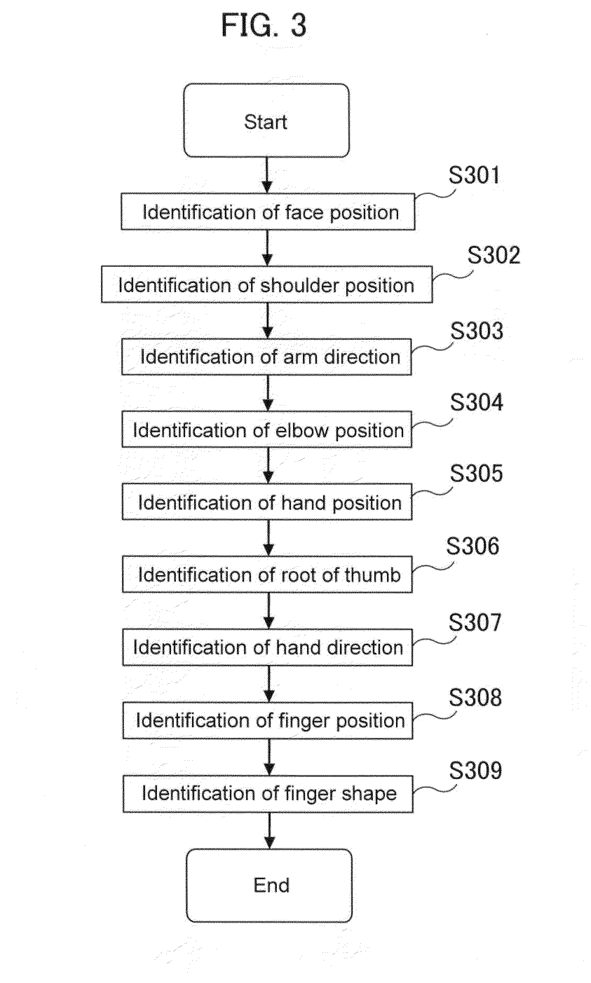

The following describes the grasping processing of the shape of the user's body. FIG. 3 is a flowchart illustrating a flow of the grasping processing of the body shape.

First, a “face position” of the user is identified (step S301). When the depth sensor or stereo camera is installed at a position as illustrated in FIG. 7, a direction of the depth sensor or stereo camera is adjusted such that the depth sensor or stereo camera covers a visible part of the user's body. When a seating position of the user is limited (i.e., when the user is seated at a driver seat), a “head position” is also limited. When an object exists at the “head position” in the range image acquired by the acquiring unit 12, the object is recognized as a “head”.

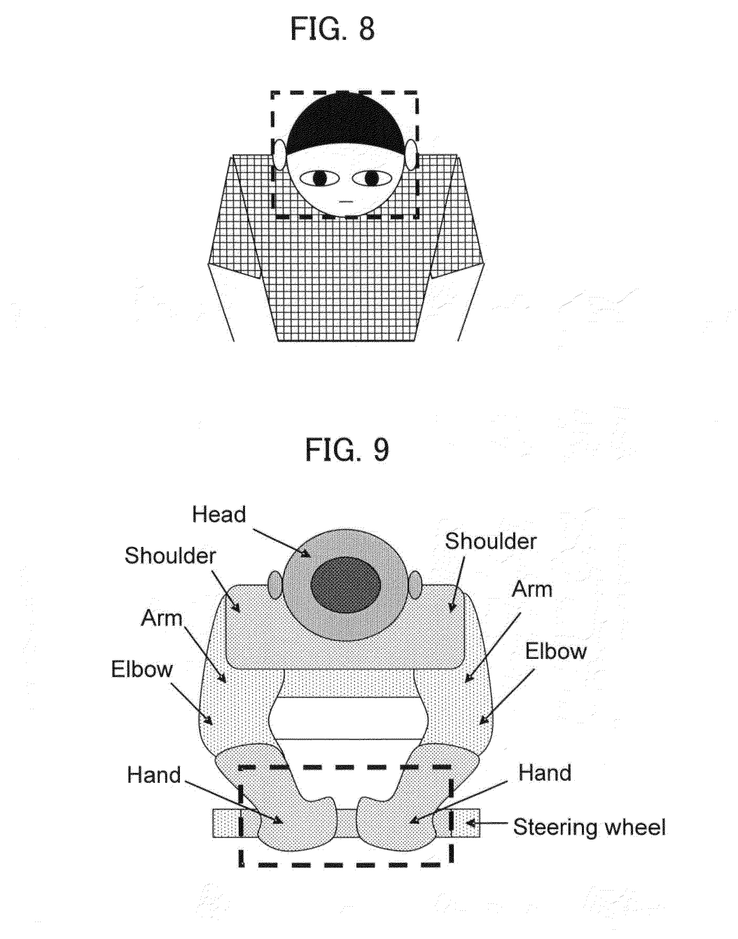

FIG. 8 is a view illustrating an example of identification of the face position. When the seating position of the user is not limited, a part of the user's body, such as the “face” (FIG. 8) that is easily recognized as a part of a person's body is identified using HoG (Histogram of Oriented Gradients). The HoG is a feature amount based on a brightness gradient for object recognition, with which a brightness gradient direction and a brightness gradient intensity are calculated for a certain (local) area to generate a gradient histogram, and the gradient direction and gradient intensity are made visible by block area based normalization.

Then, a “shoulder position” is identified (step S302). FIG. 9 is a view for explaining depth information of the body. In FIG. 9, a portion of darker color is located nearer to the viewer of FIG. 9. As illustrated in FIG. 9, the “shoulder position” is identified, using the range image, based on a gravity direction with respect to the “face position” or based on positions of eyes or mouth.

A portion extending from the “shoulder position” is identified as an “arm direction” (step S303).

A bent portion in the “arm direction” is identified as an “elbow position” (step S304).

When a portion continued from the elbow is not bent, a portion distanced, to some extent, from the elbow is identified as a “hand position” (step S305).

Then, a portion that becomes thicker or a portion where there can be seen many grooves (grooves each existing between fingers) at a position distanced from the bent portion (elbow) by a length between the shoulder and elbow is identified as a “hand”. A direction in which a thickness of the hand does not become larger is identified as a “palm”, and one of directions in which a thickness of the hand becomes larger is identified as a “direction in which a thumb exists”.

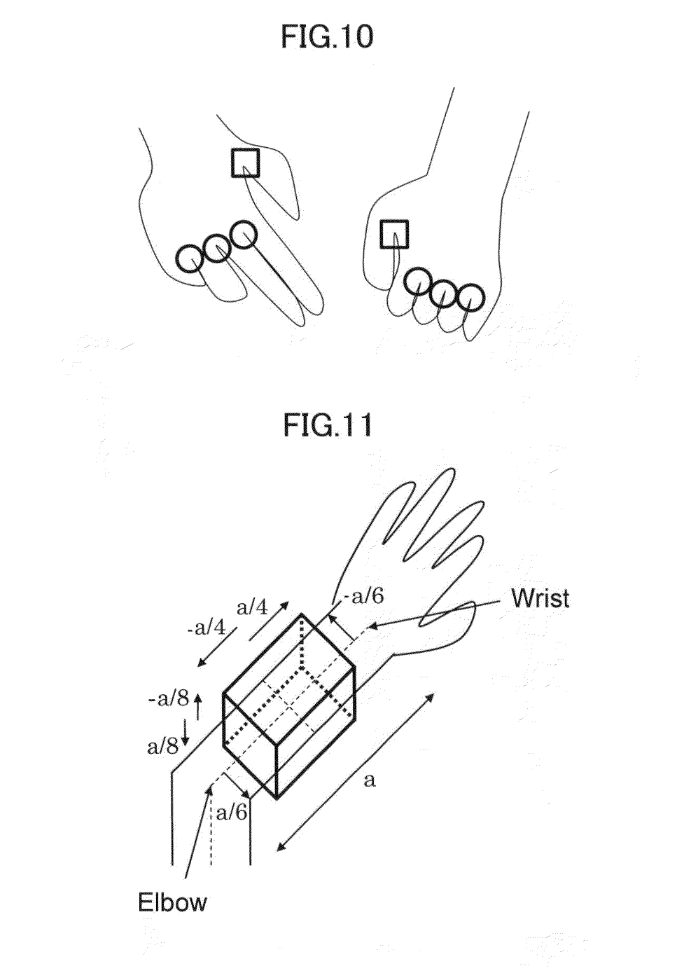

FIG. 10 is an enlarged view of an area surrounded by a broken line of FIG. 9 and is used for searching of a root of the finger. As denoted by □ in FIG. 10, a concaved portion in the direction which the thickness of the hand becomes larger found in the searching is identified as a “root of the thumb” (step S306). Since two “roots of the thumbs” can be identified, a “direction of hand” can be identified based on a direction of each thumb and based on whether the target hand is a left hand or a right hand (step S307).

As denoted by O in FIG. 10, grooves of a “root of finger” existing on a side opposite to each arm are searched for and identified. Then, how the finger extends from the “root of finger” is identified (step S308) to identify a “finger shape” (step S309).

In the manner as described above, the shape of the body can be identified.

### <Identification of Operating Position>

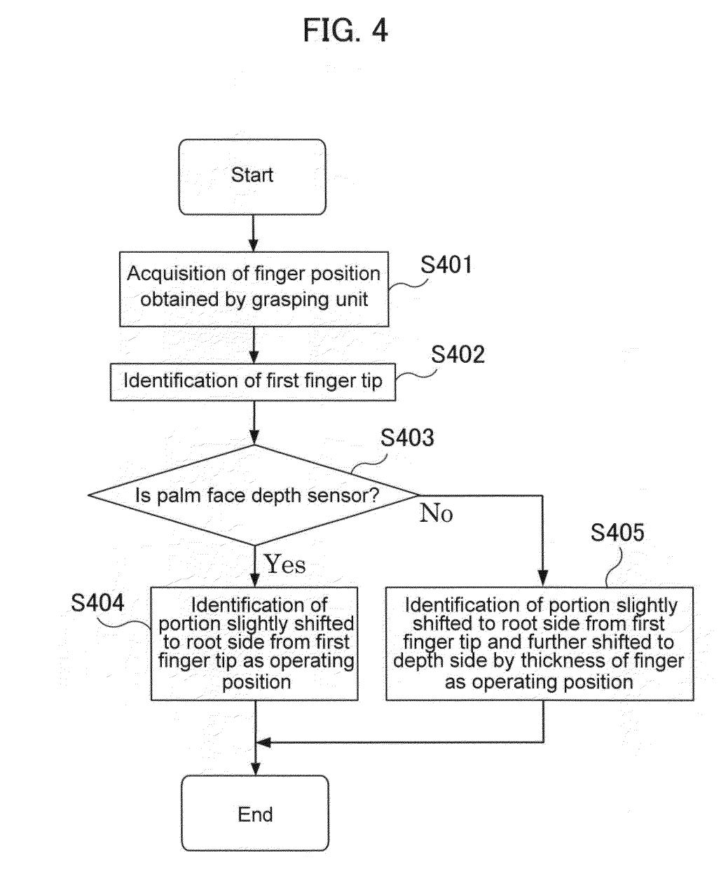

The following describes the identification of the operating position. FIG. 4 is a flowchart illustrating a flow of processing of identifying the operating position. In FIG. 4, it is assumed that operation is performed using a “nail-less side of a first finger tip”.

First, a “finger position” obtained by the grasping unit 13 is acquired (step S401).

Since a direction of the “palm” has already been identified, a portion between the root of the thumb and the groove of a finger nearest to the thumb is identified as a “first finger”. The identified “first finger” can be identified as a finger tip involved in the operation (step S402). In general, a “portion slightly shifted to the root side from the finger tip” is regarded as the operating position.

Then, it is determined whether the “palm” faces the acquiring unit 12 (here, assumed to be depth sensor) side (step S403). When the “palm” faces the depth sensor 12 side (Yes in step S403), a “portion slightly shifted to the root side from the first finger tip” detected by the depth sensor is identified as the position of the operating position (step S404).

On the other hand, when “palm” does not face the depth sensor 12 side (No in step S403), “portion slightly shifted to the root side from the first finger tip and further shifted to the depth side by a thickness of the finger” is identified as the operating position (step S405). The thickness of the finger may previously be set to a normal size, or may be measured by the depth sensor 12 with the hand rotated.

The operating position can thus be identified. The operation may be made using either the left hand finger or right hand finger. For example, when the icon is placed on the right hand, operation is made using the left hand; when the icon is placed on the left hand, operation is made using the right hand. When the icon is placed on the face, etc., both the operation made by the left hand and operation made by the right hand may be accepted. Further, the operation may be accepted only when a specific shape is formed with the fingers. Alternatively, display of the icons may be made only when a specific shape is made with the fingers. This prevents the icons from being displayed at all times, thereby reducing bothersome display. The shape formed by the fingers may be, e.g., one obtained by extending only the first and middle fingers in parallel horizontally or vertically.

### <Determination of Presence/Absence of Operation>

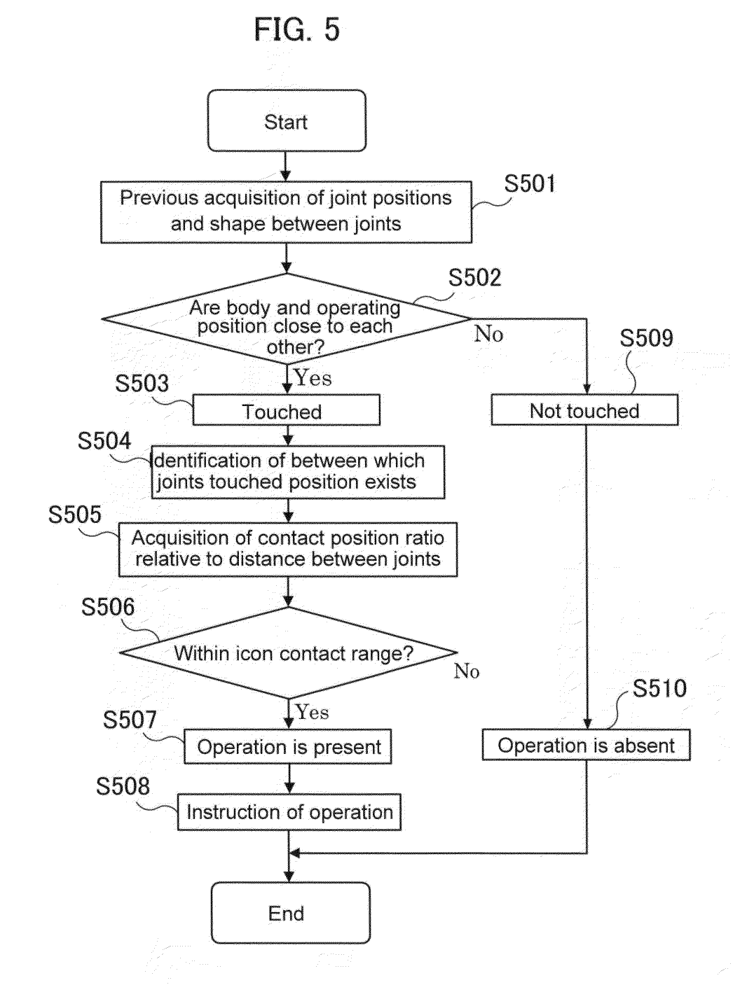

The following describes the determination of presence/absence of the operation. FIG. 5 is a flowchart illustrating a flow of processing of determining the presence/absence of the operation.

First, the “body shape” obtained by the grasping unit 13, “operation position of the first finger” obtained by the identifying unit 14, and a “positional relationship among the icons” displayed on the display unit 11 or previously determined “positional relationship among the icons” are acquired.

The details of the body shape are hidden by the hand serving as the operating position. Thus, “joint positions” immediately before being hidden and a relative “shape (distance data) between joints” are acquired (step S501). By using the “joint positions” and “shape between joints”, a depth (length) between the joints hidden by the hand serving as the operating position can be calculated from the joint positions and a depth (length) between the target joints. Even when the position of the body is changed, the “depth (length) between the joints” is relatively identified from the “joint positions”.

Then, it is determined whether or not the user's body and operating position are close to each other (step S502). A determination of whether or not touching of the operating position is made with respect to the “depth (length) between the joints” can be made based on whether a distance between a three-dimensional position of the body and a three-dimensional operating position (first finger) is smaller or not than a predetermined threshold.

When the user's body and operating position are close to each other (Yes in step S502), “touched” is determined (step S503). Then, the icon placed on the touched position is identified.

It is preferable to previously set, for each joint position, a range where touching with the corresponding icon is valid. FIG. 11 is a view for explaining an icon touch range with respect to the joint position. In FIG. 11, “a” denotes a length between the wrist and elbow representing an operation area. For example, as illustrated in FIG. 11, it is assumed that an icon between the wrist and elbow is placed in a range between a/4 and −a/4 in terms of a direction from a center of a line connecting the wrist and elbow to the wrist, in a range between a/8 and −a/8 in terms of a normal direction with respect to the palm, and in a range between a/6 and −a/6 in a direction perpendicular to both a line connecting the wrist and elbow and the normal direction with respect to the palm. Alternatively, the touching range of the icon may be defined by a radius of a sphere. In this case, for example, the touching range can be set within a range of an a/4 radius sphere whose center lies at the center of the line connecting the wrist and elbow.

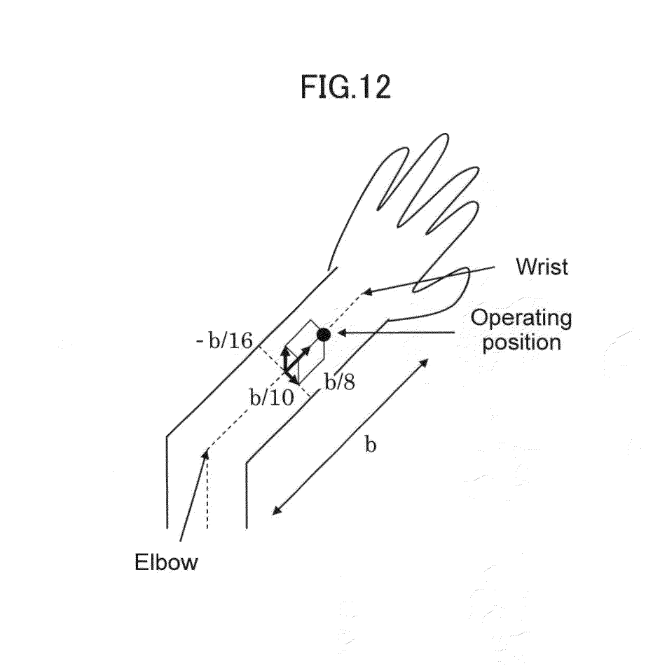

Then, it is identified between which joints the touched position exists (step S504), and a contact position ratio relative to the distance between joints is acquired (step S505). FIG. 12 is a view for explaining a contact position relative to the joint positions. In FIG. 12, “b” denotes a length between the wrist and elbow representing a contact area. For example, as illustrated in FIG. 12, the contact position ratio is identified by an area defined by a point shifted by b/8 from the center of the line connecting the wrist and elbow to the wrist side, a point shifted by −b/16 in the normal direction with respect to the palm from the center of the line connecting the wrist and elbow, and a point shifted by b/10 in the direction perpendicular to both the line connecting the wrist and elbow and the normal direction with respect to the palm from the center of the line connecting the wrist and elbow.

Calculating the contact position as a ratio relative to the distance between joints eliminates an influence of a difference in arm length or hand size among individual users, so that even if the positions of the joints are changed, it is possible to determine a specific body position as the operating position.

In FIG. 6, for example, the icons are placed respectively on the backs of the left and right hands, left and right arms (portions each between the hand and elbow), and left and right arms (portions each between the elbow to shoulder). In this case, only one icon is placed between the joints, so that it can be determined that the touching has been made even if the icon is not actually touched depending on which side of the joint is touched. According to the information obtained by the grasping unit 13, the positions of the arms can be identified from the positions of the shoulder, elbow, and hand, so that when a portion shifted to the hand side from the wrist is touched, an icon placed on the back of the hand is selected. When a portion between the wrist and elbow is touched, an icon placed between the hand and elbow is selected. When a portion between the elbow and shoulder is touched, an icon placed between the elbow and shoulder is selected.

Then, it is determined whether or not the touched position is within the icon contact range (step S506).

When it is determined that the touched position is within the icon contact range (Yes in step S506), it is determined that an icon corresponding to the touched position is selected and operation is present (step S507).

When it is determined that the icon is operated, the content to be displayed on the display unit 11 is switched through the display instructing unit 16 according to the selected icon, and an operation instruction corresponding to the selected icon is transmitted from the operation instructing unit 17 to the device 200 to be operated (step S508).

When the user's body and operating position are away from each other (No in step S502), and when the touched position is outside the icon contact range (No in step S506), it is determined that the operation is absent (step S510).

The presence/absence of the operation can thus be determined. After the touching, a sound or voice may be issued for confirmation of the touching or content of the operation. In this case, the operation is accepted only when the same icon is touched once again or continues being touched for a predetermine time, or when a specific portion (e.g., wrist) is touched as “confirmed”.

According to the first embodiment, the user's body is represented by an illustration, and the icons are superimposed on the illustration. Thus, even if the user's body moves, the positions of the icons are not changed, thereby achieving an easy-to-understand display.

### Second Embodiment

The following described a second embodiment.

An icon operating device 100 according to the second embodiment photographs the user's body using a stereo camera serving as the acquiring unit 12, displays the photographed body on a screen of the display unit 11, and places the icons on the displayed body. Touching a part of the body corresponding to the icon allows the icon to be selected.

A basic configuration of the icon operating device 100 according to the second embodiment can be made substantially the same as that of the icon operating device 100 according to the first embodiment.

An image acquired from the stereo camera 12 may directly be displayed on the display unit 11; however, in this case, there is a difference in view direction between an image as viewed from the user and an image as viewed from the stereo camera 12. Thus, in order to make the view direction same between the user and camera 12 as possible, the stereo camera 12 may be attached to user's glasses or hat. Alternatively, a three-dimensional positional arrangement obtained by the stereo camera 12 or depth sensor may be rotated or enlarged/reduced so as to make the view direction same between the user and camera 12 as possible.

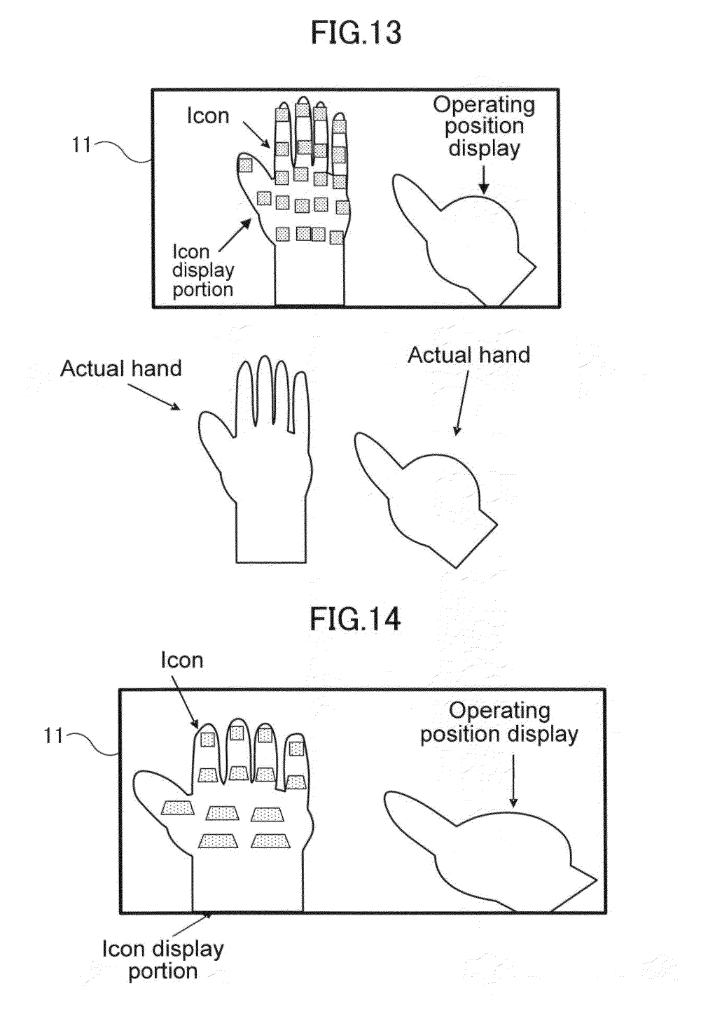

FIG. 13 is a display example in which the icons are placed on the palm. When the icons are displayed on the palm as illustrated in FIG. 13, for example, the position of each icon is calculated based on the joint positions. When the user moves, the icon placed on a portion, such as the palm, that can be easily moved or changed in shape is also moved to become hard to see. In order to avoid this, the icon may be displayed at a position relative to a fixed reference position (e.g., wrist). Further, an image acquired at a given time point may continue to be displayed as a still image.

FIG. 14 is a view illustrating an example of display of deformed icons.

In a displayed state, the position of the icon is moved so as to follow the movement of the body. At this time, as illustrated in FIG. 14, the icon may be deformed or changed in size in accordance with an inclination or depth of the hand. In this case, for more understandable visualization, the image may be displayed in a stereoscopic manner using a three-dimensional display.

When the icon is touched, an operating position display may overlap the icon. In this case, the icon may continue to be displayed without modification, or icon at the overlapping portion may be deleted. Alternatively, an image around the icon may be stored so as to allow the portion hidden by the operating position to continue being displayed, while the operation position may be deleted. Further alternatively, the operating position may be made translucence so as to allow the icon to continue being displayed, resulting in achievement of user-friendly operation display.

According to the second embodiment, a positional relationship concerning the user's body or icons to be operated becomes more easily and intuitively understandable. Further, simultaneous display of the operating position makes a relative relationship between the icons and operating position easily understandable, allowing the user to perform more intuitive operation. Further, an operation screen can be set in front of the user's eyes to eliminate the need for the user to take a look at his or her hand point by point during the operation or to move the hand in front of his or her eyes for easy viewing of the hand, thereby producing less fatigue even with long operation time.

### Third Embodiment

The following describes, a third embodiment. In the third embodiment, the icons displayed on the display unit 11 are associated with a list of song titles.

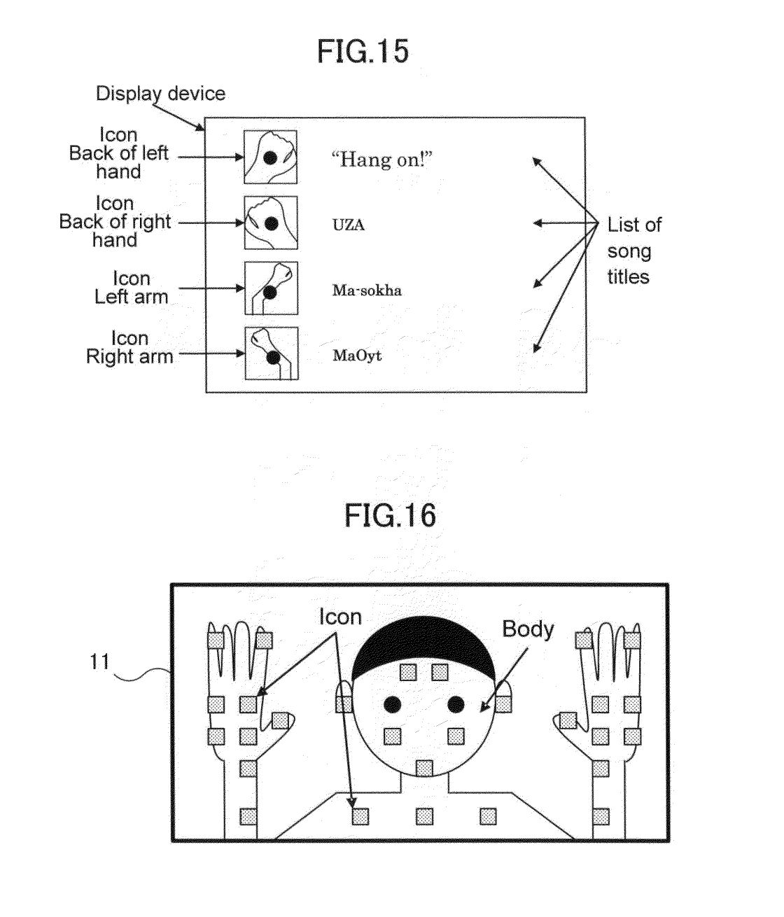

FIG. 15 is a view illustrating an example of icons displayed on the display unit 11. Displayed in the example of FIG. 15 are four icons: an icon of the back of the left hand; an icon of the back of the right hand; an icon of the left arm; and an icon of the right arm. The four icons are associated with different song titles from each other. A plurality of song titles may be displayed in a hierarchical structure with one icon.

The user who views the display of FIG. 15 can immediately determine which music can be selected by touching which one of the four icons.

The list associated with the icons is not limited to the song titles, but may be addresses registered in a navigation system or items to be selected on a web browser.

Further, as illustrated in FIG. 15, a touching point may be highlighted or may be made to blink for easy understanding.

### (Modification)

The embodiments of the present invention can be modified as follows.

The display unit may display illustrations or descriptions used in an explanatory leaflet and need not always be in a visible state.

FIG. 16 is a display example of a horizontally-reversed user's body and icons. The icons may be displayed on the face and body in the manner as illustrated in FIG. 16. In this case, the image may be mirror-reversed. In a case where an actual body is photographed using a camera, a display position may be three-dimensionally rotated and translated so that a surface of the display looks like a mirror. When the icon is placed on the face, both the operation made by the left hand and operation made by the right hand may be accepted.

In a case where two sides of the body can be used for the operation (e.g., palm and back of the hand), different icons may be used for the two sides, respectively. Further, the icon may be displayed only when, e.g., the palm on which the icon is to be placed is made to face the screen.

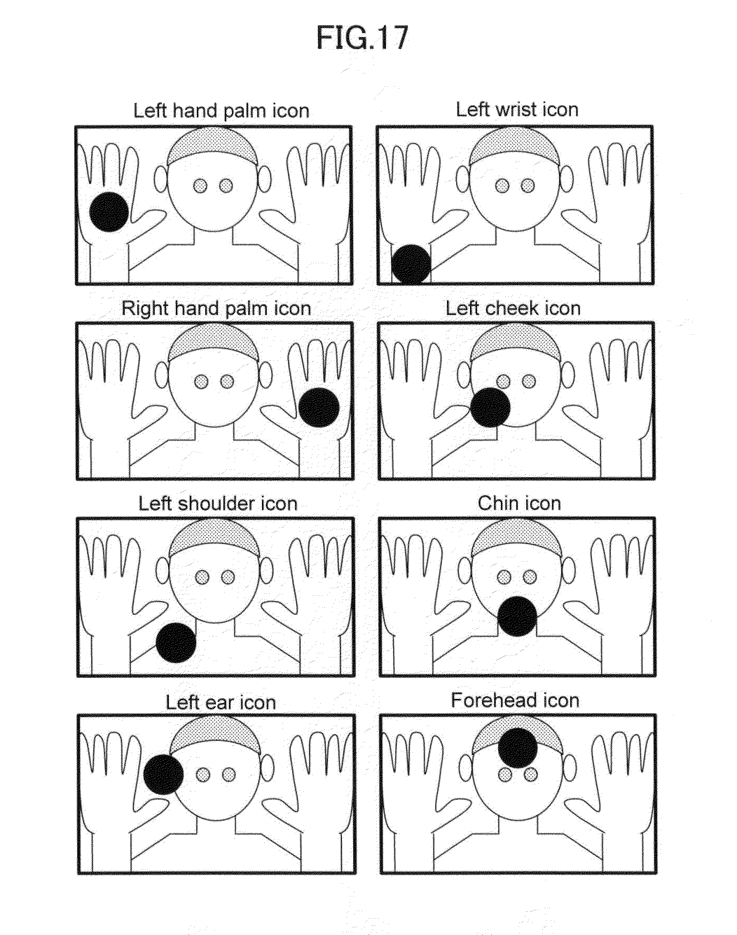

FIG. 17 is another display example of the icons on the face or body. As illustrated in FIG. 17, a display may be possible, in which a wide area including a portion to be touched may be iconized, and an indication indicating the portion to be touched is shifted to the palm of the left hand or palm of the right hand to be touched. Further, a display may be possible, in which a wide area including a portion to be touched may be iconized, and an indication indicating the portion to be touched may be shifted to the left shoulder, left ear, left wrist, or left cheek to be touched. Further, a display may be possible, in which a wide area including a portion to be touched may be iconized, and an indication indicating the portion to be touched may be shifted to the right shoulder, right ear, right wrist, or right cheek to be touched (in this case, operation is allowed to be performed with the left hand). Further, a display may be possible, in which a wide area including a portion to be touched may be iconized, and an indication indicating the portion to be touched may be shifted to the chin or forehead to be touched.

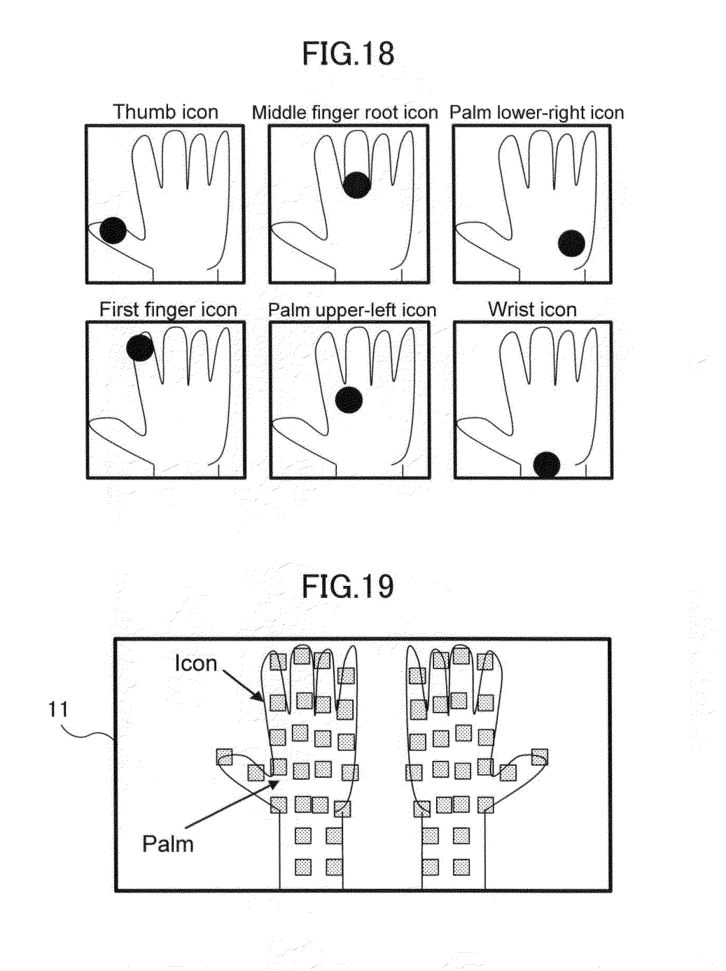

FIG. 18 is a display example of the icons using each section of the hand. As illustrated in FIG. 18, a display may be possible, in which a wide area including a portion to be touched may be iconized, and an indication indicating the portion to be touched may be shifted to the thumb, first finger, root of the middle finger, upper-left of the palm, lower-right of the palm, or wrist to be touched.

The icon operation may be made using either the left hand finger or right hand finger. For example, when the icon is placed on the right hand, operation is made using the left hand; when the icon is placed on the left hand, operation is made using the right hand.

For distinguishing from scratching action, the operation may be accepted only when a specific shape is made with the fingers, the specific shape being, e.g., one obtained by extending only the first and middle fingers in parallel horizontally or vertically.

Alternatively, display of the icons may be made only when a specific shape is made with the fingers. This prevents the icons from being displayed at all times, thereby reducing bothersome display.

FIG. 19 is a detailed display example of the user's hand and icons. When a detailed operation can be performed, e.g., at a time during stop of the vehicle, the icons may be displayed on the palm as illustrated in FIG. 19. In a case where the icons are placed on the palm, a detailed position can be identified from the position of the finger, thereby achieving a more detailed operation. Conversely, the palm or a first may be used to perform the operation for more complicated operation.

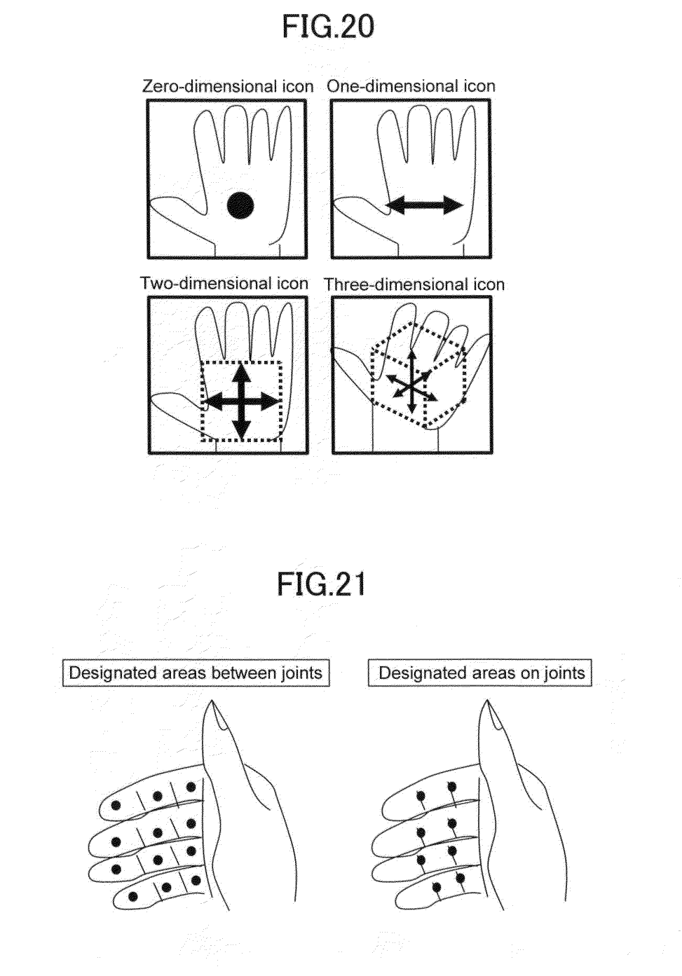

FIG. 20 is a view exemplifying an icon operable range. In general, the icon operation is a zero-dimensional (point) operation (whether being touched or not). Thus, as illustrated in FIG. 20, the icon is represented by a one-dimensional (line) slider, a two-dimensional (surface) touch pad, or a three-dimensional (solid) space recognition operating device so as to allow the user to perform analog-like operation.

### <Icon>

The icon may be displayed as a real image obtained by photographing an image using a camera. In this case, the image may be a still image obtained by a single photographing, or may be displayed in a real-time moving image. Alternatively, a display may be possible in which images of all the icons are made the same as each other, and only the positions of the indications each indicating a portion to be touched are made to differ from each other.

In a case where the camera is set so as to face the user, and where icon is displayed on the palm in a state where the palm faces the user, the palm and operating position are out of sight of the camera. In this case, the back of the hand is acquired, and a portion shifted from the back of the hand toward the palm by a thickness of the hand is identified as a portion to be touched. Further, with regard to the positions of the fingers involved in operation, the shapes of the fingers that are not hidden by the hand are acquired and then subjected to movement and rotation based on the position of the wrist or little finger assuming that the shapes of the fingers themselves are not changed. In this case, a position shifted by a thickness of the body (e.g., a position of not only the palm but the other side of the arm shifted by a thickness of the arm) may be acquired. The icon to be displayed at that time may be a previously prepared picture. Alternatively, a back side of the target area is previously photographed by the camera, and the obtained image is subjected to predetermined processing for use as the icon. Further, the image to be displayed may be switched for each user, depending on a difference in the user's face.

The operation may be accepted only when the user views a screen of a display device on which the icon is being displayed.

When the icon is too small to see (e.g., a case where the entire body is displayed), a number or a symbol associated with each part of the body may be added. In this case, for easy understanding of the association, an image representing the body and numbers (or symbol) may be displayed on the display screen.

The body icon may be replaced by a body of an animal such as a cat, or an animation character. For example, the cat has a paw pad, to which the user is more attached. Further, existence of the paw pad allows easy determination of the palm side. Further, an animal or character having a characteristic part (elephant's trunk, a rabbit ear, a giraffe's neck, etc.) may be used for easy understanding.

A priority may previously be set for the icons corresponding to respective parts of the body in terms of use frequency so as to arrange the icons in an easy-to-use order. Alternatively, the priority may be set by touching the icons in a user's desired order.

The part of the body to be touched is not especially limited. For example, a head, a back, or a foot may be set as a portion to be touched. Touching may be made valid when the position of hair, clothes, glove, or shoes is touched.

A camera may be attached to a touching side of the hand using a wrist band or a ring so as to allow confirmation of the touched position. This allows even a position (the back, back of the head, etc.) that cannot be generally captured by a single camera to be touched.

A finger approaching a target icon to be touched may be displayed in a relative position with respect to the icon. At this time, in order to prevent the icon from being invisible, the two images (finger and icon) may be translucently synthesized (alpha-blended) using a coefficient (alpha value).

FIG. 21 is an example of designated areas where indications of the portions to be touched are shifted in a case where the icons are placed on detailed portions of the fingers or where the entire palm is iconized. As illustrated in FIG. 21, the icons may be placed between the joints or on the joints so as to allow the joint of the finger or a portion between joints to be touched by the thumb of the same hand. Further, under the assumption that the camera is set so as to face the user, side surfaces of the fingers are set as portions to be touched, and the portions to be touched are set so as to be captured by the camera. For example, the side surfaces of the upper side fingers may be touched by a ball of the thumb, and side surfaces of the lower side fingers may be touched by a nail of the thumb.

### <Camera Operation>

In a case where a camera (e.g., a head-mounted display) attached to the user is used, there may a case where a total image of the user is difficult to grasp. In such a case, the camera is used to capture the entire body of the user reflected by a mirror or a glass.

### <Acceptance of Icon Operation>

In order to avoid false recognition of the icon operation, a time lag may be provided between the touching and acceptance of the operation. After the touching, a sound or voice may be issued for confirmation of the touching or content of the operation. In this case, the operation is accepted only when the same icon is touched once again or continues being touched for a predetermine time, or when a specific portion (e.g., wrist) is touched as “confirmed”. This eliminates additional display for confirmation.

According to the embodiments of the present invention, it is possible for the user (driver) to operate the device to be operated without turning his or her eyes from the traveling direction, leading to safe driving, for example. Which part of the body the user has to touch for a desired operation can be naturally memorized by repetitive learning. This eliminates the need for the user to view the display unit for confirmation of which part he or she has to touch first, leading to safer driving.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An icon operating device for a user to input a command or information to a device to be operated, comprising:
a memory that stores data concerning a plurality of icons that associates information indicating what operation can be made for the device to be operated by touching which part of a user's body with operation contents of the device to be operated;
an acquiring unit that is disposed so as to face the user and acquires a range image of the user;
a grasping unit that grasps a shape of the user's body based on the range image data acquired by the acquiring unit;
an identifying unit that identifies, based on a position of a user's finger obtained by the grasping unit, an operating position indicating which part of the body the user has touched;
a determining unit that determines selection of the icon and the content of operation for the device to be operated based on the shape of the user's body and the operating position; and
an operation instructing unit that issues an operation instruction to the device to be operated based on the determined operation content.

2. The icon operating device according to claim 1, wherein
in a case where the operation content selected by the user has been grasped by the determining unit, the operation content is notified by a voice message.

3. The icon operating device according to claim 2, wherein
in a case where the operation content selected by the user has been grasped by the determining unit, an operation instruction for the device to be operated is made valid under the condition of contact with a specific portion of the body.

4. The icon operating device according to claim 1, wherein
the determining unit accepts the operation only when the grasping unit determines the grasped body shape as a specific finger.

5. The icon operating device according to claim 1, wherein
the acquiring unit is disposed at an upper front of a driver's seat of a vehicle so as to face an upper body of the user and mounted inside the vehicle.

6. The icon operating device according to claim 1, further comprising:
a display unit that displays a part of the body based on the range image data acquired by the acquiring unit and displays the icons in a superimposed manner on the displayed body image; and
a display instructing unit that switches display content to be displayed on the display unit based on the selected icon.

7. The icon operating device according to claim 6, wherein
the display instructing unit enlarges or reduces an icon selected from among the displayed icons.

8. The icon operating device according to claim 6, wherein
the display instructing unit changes a color of an icon selected from among the displayed icons.

9. The icon operating device according to claim 6, wherein
when the selected icon has options of the next hierarchy, the display instructing unit switches the display of the selected icon.

10. The icon operating device according to claim 6, wherein
the identifying unit accepts operation made by a user's left hand when the icons are placed on a right hand displayed on the display unit and accepts operation made by the user's right hand when the icons are placed on the left hand.

11. The icon operating device according to claim 6, wherein
the display unit displays the icons on the display unit only when the grasping unit determines the grasped body shape as a specific finger.

12. The icon operating device according to claim 6, wherein
a face is displayed on the display unit, and icons are displayed in a superimposed manner on the face.

13. The icon operating device according to claim 6, wherein
a horizontally-reversed body is displayed on the display unit.

14. The icon operating device according to claim 6, wherein
a palm is displayed on the display unit, and icons are displayed in a superimposed manner on the palm.

15. The icon operating device according to claim 6, wherein
when a display in which the icons are superimposed on the body is hidden by the user's operating position, the operating position is not displayed, or two images of the icon and use's finger as the operating position are translucently synthesized using a predetermined coefficient.

16. The icon operating device according to claim 6, wherein
a display position is three-dimensionally rotated and translated so that a surface of the display looks like a mirror.

17. The icon operating device according to claim 6, wherein
the icons to be displayed are switched from one to the other depending on whether a user's hand represents the palm or the back of the hand.

18. The icon operating device according to claim 6, wherein
the icons are displayed on the display unit only when the user turns his or her palm on which the icons are placed toward the display unit.

19. The icon operating device according to claim 1, wherein
the icon operable range is set in a range specified by a slider operation as a one-dimensional line operation, a touch pad operation as a two-dimensional surface operation, or a space recognition operation as a three-dimensional operation.

20. The icon operating device according to claim 1, wherein
the icons are placed on an opposite side of the body which is out of sight of the acquiring unit considering a thickness of the body, and the operating position is estimated based on a shape of the operating position in a visible state.

21. The icon operating device according to claim 6, wherein
sections of the hand are displayed in the display unit, and the icons are displayed in a superimposed manner on the respective sections of the hand.

22. The icon operating device according to claim 21, wherein
sections of the body are displayed, as icons, on the display unit and listed for selection.
